(19) United States
(12) Patent Application Publication
(10) Pub. No.: US 2006/0011710 A1
(43) Pub. Date: Jan. 19, 2006

(54) Formation of a wire bond with enhanced pull

(75) Inventors: Wai Wah Lee, Singapore (SG); Chia Yen Cho, Singapore (SG)

Correspondence Address: OSTROLENK FABER GERB & SOFFEN, 1180 AVENUE OF THE AMERICAS, NEW YORK, NY, 100368403, US

(73) Assignee: ASM Technology Singapore Pte Ltd

(21) Appl. No.: 10/891,342

(22) Filed: Jul. 13, 2004

(51) Int. Cl. B23K 31/00

(52) U.S. Cl. 228/180.5

(57) ABSTRACT

A method of forming a wire connection using a bonding tool is provided. A first bond is first formed from a bonding wire fed from the bonding tool at a first bonding point. The bonding wire is then extended from the first bond while moving the bonding tool from the first bonding point towards a second bonding point. Thereafter, the bonding wire is mechanically deformed by contacting the bonding tool against a support surface and the bonding tool is moved in a direction away from the first bond to pull the bonding wire before forming a second bond with the bonding tool.

### FIELD OF THE INVENTION

The invention relates to the formation of wire bonds for making electrical connections, in particular, to the formation of wire bonds between bonding surfaces of semiconductor devices.

### BACKGROUND AND PRIOR ART

When making an electrical connection between bonding surfaces of semiconductor devices, ultrasonic energy may be provided to a bonding wire on the bonding surface to form the bond, either at room temperature or at elevated temperatures. There are typically two bonding points for a single bonding wire, and the distance between the two bonding points is conventionally referred to as the wire length. In a type of wire bonding process called ball-bonding, a first bond comprises a ball bond and a second bond comprises a stitch bond.

During the ball-bonding process, a molten ball that is formed by melting a tail end of the wire is placed at the first bonding point to form the ball bond and the wire is extended from the ball bond by a capillary feeding the bonding wire while the capillary moves to a second bonding point. A number of pre-programmed motions of the capillary are undertaken by the capillary during its travel from the first bonding surface to the second bonding surface in order to form a loop with a desired profile. The loop formation process is important so as, for example, to keep the profile of the wire loop low and therefore minimize the size of the assembled package, to strengthen the bond to avoid accidental dislodgement of the bond and to enhance the linearity of the wire to prevent contact with an adjacent wire.

There are various types of loops that can be formed by different motions of the capillary. One type of loop, called a square loop is illustrated in FIG. 1. It has two kinks along its profile. Other types of loops with different numbers of kinks or different loop heights and profiles can be formed by changing the motion of the capillary when moving from the first bonding point to the second bonding point. The wire loop 10 shown in FIG. 1 extends from a first bonding point on a first bonding surface 12 to a second bonding point on a second bonding surface 14. The first and second bonding surfaces 12, 14 may be fixed on a relatively flat base platform 16. The first bonding surface 12 is typically at a greater height than the second bonding surface 14. A ball bond 18 connects the bonding wire 11 to the first bonding surface 12. The ball bond 18 is so-called because it is formed by placing a molten ball of wire induced by an electronic flame off (EFO) spark placed onto the first bonding surface and thereafter attached to it by force and ultrasonic energy. A stitch bond 20 joins the wire loop 10 to the second bonding surface 14. It is formed by deforming the wire into a wedge shape by force and ultrasonic energy, and then breaking the wire at the bond.

FIG. 2 is a portion of a typical motion profile 22 of the prior art which the capillary moves when moving towards the second bonding surface 14 from the first bonding surface 12. At a top of a loop trajectory, A, the capillary moves towards the second bonding surface 14. At point B, the capillary performs a vertical pull motion (by way of Z motion of the capillary) by moving vertically downwards for a certain distance Dv to point C. Point C is at a search height Hs. A wire clamp adapted to hold the wire relative to the capillary may be open or closed during vertical pull. Thereafter, the capillary moves with constant velocity from point C to point D at a predetermined height over the second bonding point E where the stitch bond 20 is to be formed. The motion from point C to point D is by way of a table pull or horizontal pull motion, wherein the capillary is moved in synchronized x, y and z directions, usually either along the programmed wire direction or perpendicular to the programmed wire direction. The wire clamp is closed during table pull. The capillary then drops vertically from point D to the bonding point E where the stitch bond 20 is bonded. The prior art motion profile may apply vertical pull and table pull separately or in combination, by executing simultaneous vertical motion (Dv) and horizontal motion (Dh).

A problem with this prior art motion profile to form the stitch bond 20 is that when the bonding wire first touches the second bonding surface 14 at bonding point E, there is a recoil force on the wire loop 10 because of the shock of the impact force of the capillary on the second bonding surface 14. This recoil force, which is acting in a direction away from the second bonding surface 14, is transmitted throughout the wire loop 10 and may deform the shape of the wire loop 10.

While the vertical pull and table pull motions may be sufficient to reduce the recoil effect for common and undemanding applications, they are insufficient for bonding ultra low wire loop packages, where a height differential between the first bonding point on the first bonding surface 12 to the second bonding point on the second bonding surface 14 is less than 3.0 mils and/or the distance between the first and second bonding points or wire length is 3.5 mm or longer. Another factor that adds to the recoil effect is when a diameter of the bonding wire is 1.0 mil or smaller. In FIG. 3, a deformed wire loop 10′ is shown as compared to a standard wire loop 10. The recoil force causes deformation of the wire loop to a hump-shaped elevation. The misshapened profile of the wire loop 10′ affects consistency of the wire loop profile and repeatability.

### SUMMARY OF THE INVENTION

It is therefore an object of the invention to seek to provide a method of forming wire loops with more consistent loop profiles and greater repeatability as compared to the aforesaid prior art, especially but not exclusively for low loop packages.

Accordingly, the invention provides a method of forming a wire connection using a bonding tool comprising the steps of: forming a first bond from a bonding wire fed from the bonding tool at a first bonding point; extending the bonding wire from the first bond while moving the bonding tool from the first bonding point towards a second bonding point; mechanically deforming the wire by contacting the bonding tool against a support surface; moving the bonding tool to pull the bonding wire in a direction away from the first bond; then forming a second bond with the bonding tool.

It would be convenient hereinafter to describe the invention in greater detail by reference to the accompanying drawings which illustrate one embodiment of the invention. The particularity of the drawings and the related description is not to be understood as superseding the generality of the broad identification of the invention as defined by the claims.

### BRIEF DESCRIPTION OF THE DRAWINGS

A method of forming a wire bond in accordance with the invention will now be described with reference to the accompanying drawings, which is shown solely by way of a non-limiting demonstrative example of the present invention, in which:

FIG. 1 is a side view of a typical square wire loop used to electrically connect two bonding surfaces;

FIG. 2 is a side view of a prior art motion profile of a capillary for forming a stitch bond on a second bonding surface;

FIG. 3 is a side view of a deformed wire loop that may occur when using the prior art motion profile as shown in FIG. 2;

FIG. 4 is a side view of a motion profile of a capillary according to the preferred embodiment of the invention;

FIG. 5 is a side view of the wire loop formed using the motion profile of FIG. 4 just before the capillary touches down onto the second bonding surface;

FIG. 6 is a side view of the wire loop at the first touchdown of the capillary on the second bonding surface using the said motion profile; and

FIG. 7 is a side view of the wire loop at the second touchdown of the capillary on the second bonding surface after table pull using the said motion profile.

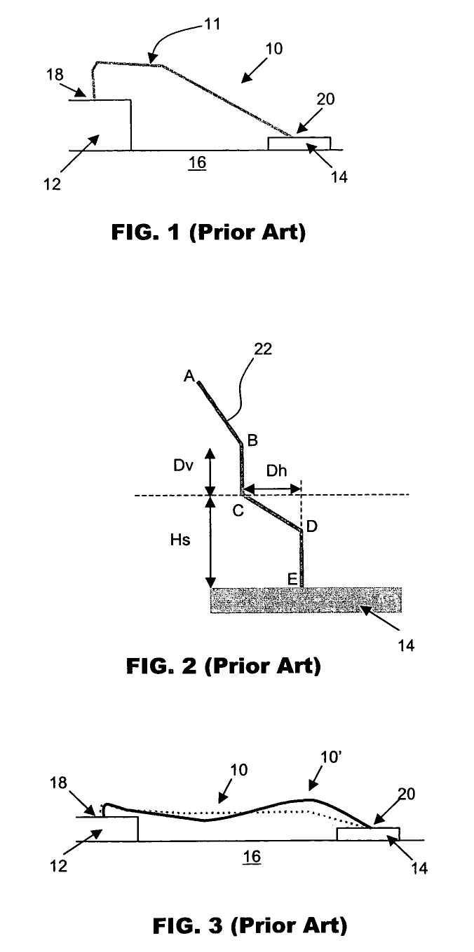

### DETAILED DESCRIPTION OF THE PREFERRED EMBODIMENT

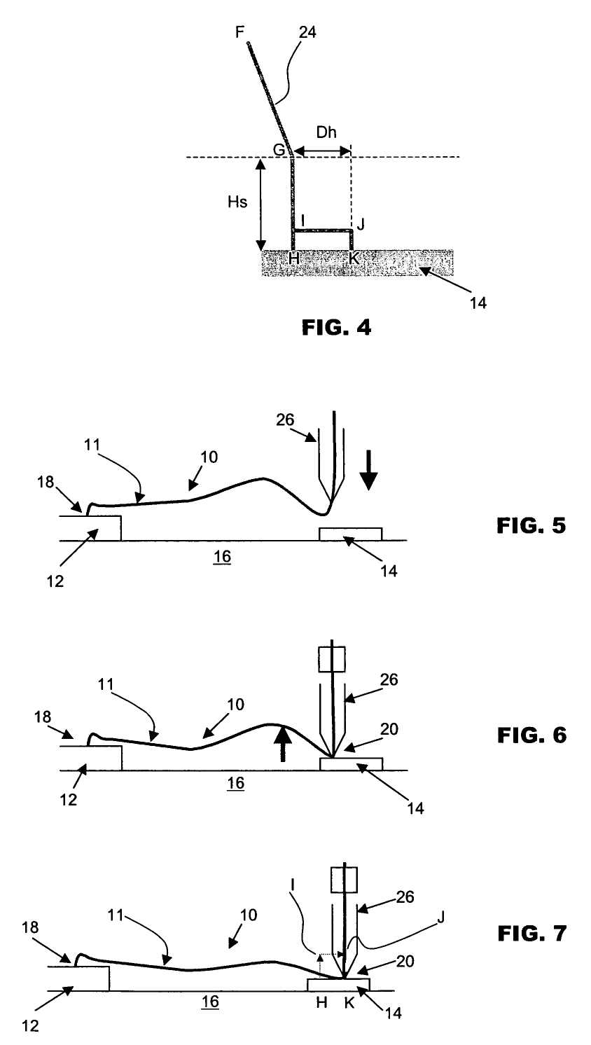

FIG. 4 is a side view of a motion profile 24 of a bonding tool in the form of a capillary attached to an ultrasonic transducer according to the preferred embodiment of the invention. The capillary of the bonding tool forms a first bond from a bonding wire fed from the bonding tool at a first bonding point. The capillary then extends the bonding wire from the first bond while it is moved from the first bonding point towards a second bonding point in a loop trajectory so as to form a loop profile. From a top of a trajectory loop at point F indicated in FIG. 4, the capillary moves towards the second bonding surface 14 until a search height Hs, where it is positioned over a second bonding surface 14 at point G.

From point G, the capillary is driven down vertically in substantially a straight line to make a first contact on a support surface on the second bonding surface 14 at point H. The support surface at point H is preferably spaced from the second bonding point K in the direction of the first bonding point, and also preferably lies together with the second bonding point K on a substantially horizontal plane. This first contact does not impart any bonding force onto the bonding wire so that any recoil force is minimized. Further, it mechanically deforms the wire protruding from the tip of the capillary by bending the bonding wire at a contact point between the capillary tip and the support surface. This step is operative as to facilitate the straightening of the bonding wire along its length prior to actual bonding at the second bonding point K.

From point H, the capillary is lifted to a predetermined height over the second bonding surface 14 at point I. Horizontal pull or table pull is then exerted on the bonding wire at this stage by moving the capillary in a direction away from the first bond towards the second bonding point in an effort to extend and straighten the bonding wire, such that the capillary is moved by a horizontal distance Dh to point J. From point J, the capillary contacts the second bonding surface 14 for a second time, at bonding point K. A second bond, commonly a stitch bond, is formed at bonding point K. Table pull is therefore applied between the contact position H, where there is likely to be a recoil force on the wire, and the second bonding point K.

FIG. 5 is a side view of the wire loop 10 formed using the motion profile of FIG. 4 just before the capillary 26 touches down onto the second bonding surface 14. The second bonding surface 14 and the first bonding surface 12 are fixed on a relatively flat base platform 16. This is the wire profile that is presented as the capillary 26 moves between points G and H shown in FIG. 4. Bonding wire 11 has been fed through the tip of the capillary 26 and is now held tightly by a wire clamp (not shown) just before forming the second bond or stitch bond so that the feeding of wire from the capillary 26 is stopped when contacting the capillary 26 against the support surface.

FIG. 6 is a side view of the wire loop 10 at the first touchdown of the capillary 26 on the support surface of the second bonding surface 14 at point H using the said motion profile. There is some recoil force experienced in the bonding wire so that a portion of the bonding wire near the capillary would tend to move upwards relative to the rest of the bonding wire. The contacting of the capillary 26 on the bonding surface deforms the wire 11 at the tip of the capillary 26.

FIG. 7 is a side view of the wire loop 10 at the second touchdown of the capillary 26 on the second bonding surface 14 after table pull using the said motion profile. The wire has been deformed after contact with the bonding surface 14 at point H. The capillary 26 has moved from point H to point I then to point J before touching down at second bonding point K. These motions are executed whilst feeding of bonding wire from the capillary 26 is stopped. The table pull motion while the capillary 26 was moved relatively from point I to point J helps to straighten out any deformities in the wire loop 10 prior to making the stitch bond 20. A stitch bond 20 is then formed at point K using ultrasonic energy generated at the capillary 26.

It would be appreciated that the wire bonding process according to the invention reduces the effect of high impact force on the bonding wire that may give rise to inconsistency in the wire profile using prior art wire bonding methods. The table pull effect that is used to straighten the wire profile is also enhanced. For example, the prior art process requires a minimum table pull distance of at least 5 mils (127 μm) whereas the preferred embodiment of the invention is more effective and may require a minimum table pull distance of only 25 μm. As a result, the distance with which the bonding wire is pulled in a direction away from the first bond may be reduced to between 25 μm and 120 μm.

Using the said prior art process, the extent of wire deformation caused by the recoil force tends to depend on the wire bonding direction or orientation of the wire connection, because the impact force from bonding varies with the direction in which the capillary carries the bonding wire. Therefore, the degree of wire deformation would vary according to the respective orientation between the first bonding surface and the second bonding surface. This leads to greater inconsistency in the wire profiles. Since the recoil effect on the bonding wire may be reduced by the preferred embodiment of the invention, a stable and consistently-formed loop shape is achievable even for different orientations of wire connections.

The invention described herein is susceptible to variations, modifications and/or additions other than those specifically described and it is to be understood that the invention includes all such variations, modifications and/or additions which fall within the spirit and scope of the above description.

1. A method of forming a wire connection using a bonding tool comprising the steps of:
forming a first bond from a bonding wire fed from the bonding tool at a first bonding point;
extending the bonding wire from the first bond while moving the bonding tool from the first bonding point towards a second bonding point;
mechanically deforming the wire by contacting the bonding tool against a support surface;
moving the bonding tool to pull the bonding wire in a direction away from the first bond; then
forming a second bond with the bonding tool.

2. The method as claimed in claim 1, wherein the support surface is located away from the second bonding point.

3. The method as claimed in claim 2, wherein the support surface is located between the first and second bonding points.

4. The method as claimed in claim 1, wherein the support surface and second bonding point lie on a substantially horizontal plane.

5. The method as claimed in claim 1, wherein the step of contacting the bonding tool against the support surface includes the steps of positioning the bonding tool at a search height over the support surface, and driving the bonding tool substantially in a straight line from the search height onto the support surface.

6. The method as claimed in claim 1, wherein the step of mechanically deforming the bonding wire includes bending the bonding wire at a contact point between the bonding tool and the support surface.

7. The method as claimed in claim 1, wherein the step of pulling the bonding wire in a direction away from the first bond comprises applying a force adjacent to a portion of the bonding wire that is mechanically deformed.

8. The method as claimed in claim 7, wherein the step of pulling the bonding wire in a direction away from the first bond is operative to straighten the wire along its length.

9. The method as claimed in claim 1, wherein the step of pulling the bonding wire in a direction away from the first bond comprises the steps of raising the bonding tool to a predetermined height above the support surface and moving the bonding tool in a substantially horizontal direction towards the second bonding point.

10. The method as claimed in claim 1, wherein feeding of wire from the bonding tool is stopped while contacting the bonding tool against the support surface.

11. The method as claimed in claim 1, wherein feeding of wire from the bonding tool is stopped while pulling the bonding wire in a direction away from the first bond.

12. The method as claimed in claim 1, wherein the bonding tool comprises a capillary attached to an ultrasonic transducer.

13. The method as claimed in claim 1, wherein a height differential between the first bonding point and the second bonding point is less than 3 mils.

14. The method as claimed in claim 1, wherein a distance between the first and second bonding points is 3.5 mm or greater.

15. The method as claimed in claim 1, wherein a diameter of the bonding wire is 1.0 mil or smaller.

16. The method as claimed in claim 1, wherein the bonding wire is pulled in the direction away from the first bond for a distance of between 25 μm and 120 μm.
